(19) United States
(12) Patent Application Publication
(10) Pub. No.: US 2026/0039723 A1
(43) Pub. Date: Feb. 5, 2026

(54) SYSTEMS AND METHODS FOR INDICATING SPATIAL MAP EMPLOYMENT FOR LOCALIZATION SERVICES

(71) Applicant: Samsung Electronics Co., Ltd., Suwon-si (KR)

(72) Inventors: Sapan Pramodkumar SHAH, Bengaluru (IN); Arunprasath RAMAMOORTHY, Bengaluru (IN); Narendranath Durga TANGUDU, Bengaluru (IN); Vijay SANGAMESHWARA, Bengaluru (IN)

(21) Appl. No.: 19/288,321

(22) Filed: Aug. 1, 2025

(30) Foreign Application Priority Data
Aug. 5, 2024 (IN) 202441059028
Apr. 9, 2025 (IN) 2024 41059028

(51) Int. Cl. H04L 67/52; H04W 12/08

(52) U.S. Cl. CPC H04L 67/52; H04W 12/08

(57) ABSTRACT

Embodiments herein disclose methods for indicating a spatial map employment for a localization service. The method includes sending, by a first entity (102), a subscribe request to subscribe for a spatial map employed event to a second entity (112). The subscribe request may include a map identity, an identity associated with a requestor, and at least one security parameter. The method further includes receiving, by the first entity (102), a success response from the second entity (112) based on the subscribe request. The success response may include a subscription identity.

### CROSS-REFERENCE TO RELATED APPLICATION(S)

This application is based on and claims priority under 35 U.S.C. § 119 (a) of an Indian Provisional patent application number 202441059028, filed on Aug. 5, 2024, in the Indian Patent Office, and of an Indian Complete patent application No. 202441059028, filed on Apr. 9, 2025, in the Indian Patent Office, the disclosure of each of which is incorporated by reference herein in its entirety.

### BACKGROUND

### 1. Field

The disclosure relates to a localization service (e.g., metaverse service or the like). More particularly, the disclosure relates to systems and methods for indicating spatial map employment for the localization service.

### 2. Description of Related Art

Fifth generation (5G) mobile communication technologies define broad frequency bands such that high transmission rates and new services are possible, and can be implemented not only in “Sub 6 GHz” bands such as 3.5 GHZ, but also in “Above 6 GHz” bands referred to as millimeter-wave (mmWave) including 28 GHz and 39 GHZ. In addition, it has been considered to implement sixth generation (6G) mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide systems and methods for indicating spatial map employment for a localization service.

Another aspect of the disclosure is to disclose systems and methods for informing a vertical application layer (VAL) server when a spatial map is ready for employment for the localization service.

Another aspect of the disclosure is to send, by the first entity, a subscribe request to subscribe for a spatial map employed event to a second entity.

Another aspect of the disclosure is to receive, by the first entity, a success response including a subscription identity from the second entity based on the subscribe request.

Another aspect of the disclosure is to receive, by the first entity, a notification about an occurrence of the spatial map employed event from the second entity, when the second entity detects that the second entity has sufficient information to map all the objects related to an area of interest of a spatial map, and the spatial map is ready to provide the localization service.

Another aspect of the disclosure is to receive the success response from the second entity, on the second entity successfully authorizing the requestor.

Additional aspects will be set forth in part in the description which follows and, in part, will be apparent from the description, or may be learned by practice of the presented embodiments.

In accordance with an aspect of the disclosure, a method for indicating a spatial map employment for a localization service is provided. The method includes sending, by a first entity, a subscribe request to subscribe for a spatial map employed event to a second entity. The subscribe request includes a map identity, an identity associated with a requestor, and at least one security parameter. The method further includes receiving, by the first entity, a success response from the second entity based on the subscribe request, wherein the success response comprises a subscription identity.

In accordance with an aspect of the disclosure, a method performed by a first entity in a communication system is provided. The method includes transmitting, to a second entity, a first request message to create a spatial map associated with an area of interest, and in case that the spatial map produced based on a processed sensor data is not ready to provide service, receiving, from the second entity, a first response message including information indicating in-progress.

In accordance with an aspect of the disclosure, a method performed by a second entity in a communication system is provided. The method includes receiving, from a first entity, a first request message to create a spatial map associated with an area of interest, producing the spatial map based on a processed sensor data, and in case that the spatial map is not ready to provide service, transmitting, to the first entity, a first response message including information indicating in-progress.

In accordance with an aspect of the disclosure, a first entity in a communication system is provided. The first entity includes a transceiver, and a controller coupled with the transceiver and configured to transmit, to a second entity via the transceiver, a first request message to create a spatial map associated with an area of interest, and in case that the spatial map produced based on a processed sensor data is not ready to provide service, receive, from the second entity via the transceiver, a first response message including information indicating in-progress.

In accordance with an aspect of the disclosure, a second entity in a communication system is provided. The second entity includes a transceiver, and a controller coupled with the transceiver and configured to receive, from a first entity via the transceiver, a first request message to create a spatial map associated with an area of interest, produce the spatial map based on a processed sensor data, and in case that the spatial map is not ready to provide service, transmit, to the first entity via the transceiver, a first response message including information indicating in-progress.

In accordance with another aspect of the disclosure, a method for indicating a spatial map employment for a localization service is provided. The method includes receiving, by a second entity, a subscribe request to subscribe for a spatial map employed event from a first entity. The request includes a map identity, an identity associated with a requestor, and one or more security parameter(s). The method further includes sending, by the second entity, a success response including a subscription identity to the first entity, on successfully authorizing the first entity based on the received subscribe request.

In accordance with another aspect of the disclosure, a first entity is provided. The first entity includes a processor, memory, and a spatial map employment controller, coupled with the processor and the memory. The spatial map employment controller is configured to send a subscribe request to subscribe for a spatial map employed event to a second entity, where the subscribe request includes a map identity, an identity associated with a requestor and at least one security parameter. Further, the spatial map employment controller is further configured to receive a success response from the second entity based on the subscribe request, where the success response comprises a subscription identity.

In accordance with another aspect of the disclosure, a second entity is provided. The second entity includes a processor, memory, and a spatial map employment controller, coupled with the processor and the memory. The spatial map employment controller is configured to receive a subscribe request to subscribe for a spatial map employed event from a first entity, wherein the request comprises a map identity, an identity associated with a requestor and at least one security parameter. The spatial map employment controller is further configured to send a success response including a subscription identity to the first entity, on successfully authorizing the first entity based on the received subscribe request.

An embodiment of the disclosure provides systems and methods for indicating spatial map employment for a localization service.

An embodiment of the disclosure provides systems and methods for informing a vertical application layer (VAL) server when a spatial map is ready for employment for the localization service.

An embodiment of the disclosure provides a method to send, by the first entity, a subscribe request to subscribe for a spatial map employed event to a second entity.

An embodiment of the disclosure provides a method to receive, by the first entity, a success response including a subscription identity from the second entity based on the subscribe request.

An embodiment of the disclosure provides a method to receive, by the first entity, a notification about an occurrence of the spatial map employed event from the second entity, when the second entity detects that the second entity has sufficient information to map all the objects related to an area of interest of a spatial map, and the spatial map is ready to provide the localization service.

An embodiment of the disclosure provides a method to receive the success response from the second entity, on the second entity successfully authorizing the requestor.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 shows a schematic overview of a system to subscribe for a spatial map employed event from a first entity perspective, according to an embodiment of the disclosure;

FIG. 2A depicts a flowchart of a method to subscribe for the spatial map employed event from the first entity perspective, according to an embodiment of the disclosure;

FIG. 2B depicts a flowchart of a method to send the subscribe request to subscribe for the spatial map employed event to the second entity by the first entity while subscribing the spatial map employed event from the first entity perspective, according to an embodiment of the disclosure;

FIG. 3 shows a schematic overview of a system to subscribe for a spatial map employed event from a second entity perspective, according to an embodiment of the disclosure;

FIG. 4A depicts a flowchart of a method to subscribe for the spatial map employed event from the second entity perspective, according to an embodiment of the disclosure;

FIG. 4B depicts a flowchart of a method to send the subscribe request to subscribe for the spatial map employed event to the second entity by the first entity while subscribing for the spatial map employed event from the second entity perspective, according to an embodiment of the disclosure;

FIG. 5 depicts an example sequence diagram of a procedure to subscribe for the spatial map employed event, according to an embodiment of the disclosure;

FIG. 6 depicts an example procedure for the authorized spatial map consumer (e.g., the first entity) to subscribe the spatial map event, according to an embodiment of the disclosure; and

FIG. 7 depicts an example sequence diagram for notifying the spatial map event operation between the authorized spatial map consumer (e.g., the first entity) and a SEAL spatial map (SM) server (e.g., second entity), according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.”, “i.e.,” are merely used herein to mean “serving as an example, instance, or illustration.” Any embodiment or implementation of the subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the various embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the various embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

A metaverse is an interactive and immersive system to enhance user experience using an Extended Reality (XR) media, including a haptic media. A 3^{rd} Generation Partnership Project (3GPP) is working to provide localized metaverse service experience to a user—that is, a user interaction and information provided by a service to the user that is relevant to a physical location in which the user accesses the service. A localized mobile metaverse service is immersive and integrated into a user's ordinary experiences. Such service experiences are location-related and can include presentation of an Augmented reality (AR) and a Mixed reality (MR) media. The localized experience is effectively present in the user's environment, so that a mobile metaverse media provided for a given mobile metaverse service is both appropriate to and integrated with both the physical world and with mobile metaverse media content displayed.

A spatial map is a collection of information that corresponds to space, including information gathered from various sensors concerning characteristics of the forms in that space, especially appearance information. The spatial map is created using processed sensor data. The spatial map can be used to provide a localized mobile metaverse experience.

The creation and maintenance of the spatial map is referred to as spatial mapping service and the employment of the map to identify a customer's localization is termed as a spatial localization service. The spatial mapping will classify objects into modelling and tracking of stationary and moving objects. For the stationary object, spatial mapping has to estimate a number of objects, a type of object and position of object. Whereas for the moving objects, the spatial mapping has to determine the position of the moving objects, type of object, direction of the moving objects, and speed of the moving objects.

Currently, the 3GPP is working on specifying an application enabler layer to provide the spatial mapping service to a vertical application layer (VAL) server or a metaverse application. In current specification, while producing the spatial map, an enabler server can also provide the stationary object details and the moving object details (like object type, direction and speed) in a response. However, the spatial map can be very complex and may not be produced immediately upon a request from the VAL server or the enabler client. In such cases, there is no mechanism available for the enabler server to indicate to the VAL server (or the enabler client) that the spatial map is currently not ready, and the spatial map is being produced. There is also no mechanism available to indicate an expected time by when the spatial map will be ready for employment. Also, once the enabler server has sufficient information available, there is no mechanism to indicate to the VAL server (or the enabler client) that the spatial map is ready for the employment. Further, if the spatial map is created or generated based on the request from a first VAL server, there is no mechanism available for another authorized second VAL server to know when the spatial map will be ready for the employment. The first VAL server and the second VAL server require to know when the spatial map will be ready for the employment, so that the VAL server(s) can provide appropriate services to their end user. Without such information, the metaverse application may fail and the end user may experience service interruptions.

Hence, there is a need in the art for solutions which will overcome the above-mentioned drawback(s), among others

The embodiments herein achieve systems and methods for indicating spatial map employment for localization services.

In an example, an enabler server sends “in-progress” response to a request from an enabler client to produce spatial map—as the enabler server does not have sufficient data to produce the spatial map. Further, the enabler client sends a subscribe request to enabler server to get notification when spatial map is ready for the employment. Further, the enabler server detects that it has sufficient data to produce the spatial map and sends notification to the enabler client indicating spatial map is ready for the localization service.

Upon receiving the request to produce a spatial map of an area of interest, a second entity (for e.g. an enabler server or the like) sends an in-progress response indicating that the spatial map creation is in progress. The response also includes the expected time by when the spatial map will be ready for the employment. A first entity (for e.g. an application server, an enabler client or the like) subscribes to the second entity for the spatial map employed event. The second entity sends a notification to the first entity (e.g., VAL server or the enabler client) about spatial map employment. The second entity is determined to reject the localization request from the first entity, if the spatial map has not been employed yet.

The proposed method can be used to enable a consumer to subscribe for the event when the spatial map is ready for the localization service. The proposed method can be used to provide a notification to the consumer when the enabler server detects that the spatial map is ready for the localization service. This results in improving the user experience. The proposed method can be used to enable the requestor (who requested to produce spatial map) to know when the requested spatial map is ready to provide localization service. This results in enhancing the user experience.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

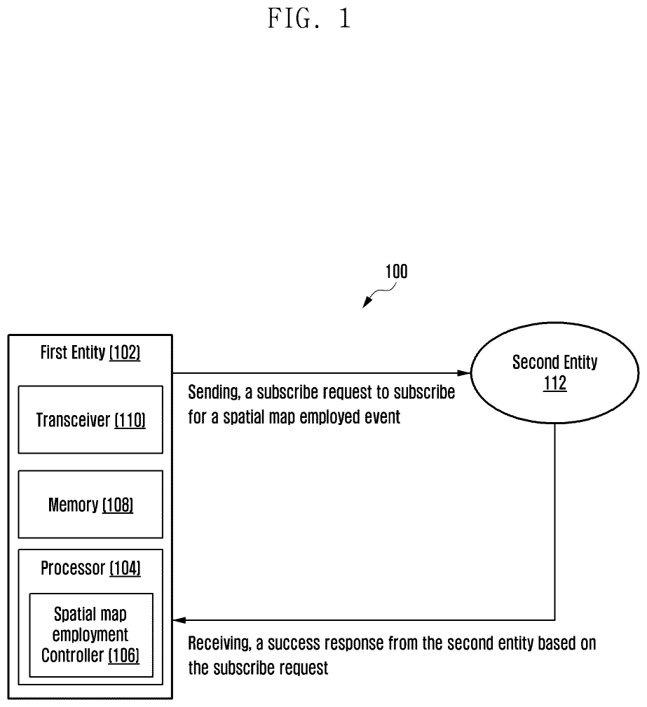

Referring now to the drawings, and more particularly to FIGS. 1, 2A, 2B, 3, 4A, 4B, and 5 to 7, where similar reference characters denote corresponding features consistently throughout the figures, there are shown embodiments.

FIG. 1 shows a schematic overview of a system 100 to subscribe for a spatial map employed event, according to an embodiment of the disclosure.

The system 100 can be, for example, but is not limited, to a fourth-generation wireless network, a fifth-generation wireless network, Open Radio Access Network (ORAN), a sixth generation (6G) network or the like. The system 100 includes a first entity 102 and a second entity 112. The first entity 102 can be, for example, but is not limited to, a Vertical Application Layer (VAL) server, a Service Enabler Architecture Layer (SEAL) Spatial Map (SM) client, and an enabler client. The second entity 112 can be, for example, but is not limited to at least one of: an enabler server, the enabler client and a SEAL SM server.

In an embodiment herein, the enabler client can be, for example, but is not limited to a Service Enabler Architecture Layer (SEAL) Location Management (LM) client, an Edge Enabler Client (EEC), an Application Data Analytics Enablement (ADAE) server client, the SEAL spatial mapping management client, the SEAL spatial anchor management client, or any other SEAL client.

In an embodiment herein, the enabler server can be, for example, but is not limited to a Service Enabler Architecture Layer (SEAL) Location Management (LM) server, an Edge Enabler Server (EES), an Application Data Analytics Enablement (ADAE) server, a SEAL spatial mapping management server, a SEAL spatial anchor management server, or any other SEAL server.

In an embodiment herein, the system 100 may be implemented on, for example, but not limited to devices with immersive experience, such as an augmented reality (AR) device, a virtual reality (VR) device or an extended reality (XR) device. The devices may include but are not limited to, a laptop, a smart phone, a desktop computer, a notebook, a Device-to-Device (D2D) device, a vehicle to everything (V2X) device, a foldable phone, a smart TV, a tablet, a television, a connected car, an immersive device, an internet of things (IOT) device, or any other device that can communicate using the wireless network.

In an embodiment herein, the first entity 102 comprises a processor 104, a spatial map employment controller 106, a transceiver 110, and memory 108. In an embodiment herein, the spatial map employment controller 106 is a part of the processor 104, where the spatial map employment controller 106 communicates with the entities (client and servers) through the transceiver 110. In another embodiment herein, the spatial map employment controller 106 is outside the processor 104 but the spatial map employment controller 106 is in communication with the processor 104, where the spatial map employment controller 106 communicates with the second entity 112 through the transceiver 110. In another embodiment herein, the spatial map employment controller 106 is outside the processor 104, and the spatial map employment controller 106 works separately from the processor 104, where the spatial map employment controller 106 communicates with the second entity 112 through the transceiver 110.

In an embodiment herein, the memory 108 is configured to store instructions to be executed by the processor 104. The memory 108 can include non-volatile storage elements. Examples of such non-volatile storage elements may include magnetic hard discs, optical discs, floppy discs, flash memories, or forms of electrically programmable read only memories (EPROM) or electrically erasable and programmable ROM (EEPROM). In addition, the memory 108 may, in some examples, be considered a non-transitory storage medium. The term “non-transitory” may indicate that the storage medium is not embodied in a carrier wave or a propagated signal. However, the term “non-transitory” should not be interpreted that the memory is non-movable. In some examples, the memory 108 is configured to store larger amounts of information. In certain examples, a non-transitory storage medium may store data that can, over time, change (e.g., in Random Access Memory (RAM) or cache).

The processor 104 may include one or more processor(s). The one or more processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 104 may include multiple cores and is configured to execute the instructions stored in the memory 108.

In an embodiment, the transceiver 110 includes an electronic circuit specific to a standard that enables wired or wireless communication. The transceiver 110 is configured to communicate internally between internal hardware components of the first entity 102 and with external devices via one or more networks.

In an embodiment herein, the first entity 102 may request a second entity 112 to produce a spatial map for an area of interest. The request also includes location (e.g. Uniform Resource Locator (URL)) from where the second entity 112 can access a sensor data. The second entity 112 may have started producing the spatial map based on the processed sensor data.

In an embodiment herein, there may not be sufficient sensor data available for producing the spatial map. Therefore, the second entity 112 needs to wait for more processed sensor data to be available in order to complete producing the spatial map. In that case, the first entity 102 receives a response message through the spatial map employment controller 106 from the second entity 112 with the result parameter set to “in-progress” value indicating that the spatial map is being produced. The response message also includes an expected time, when the spatial map will be produced and employed for the localization service.

In an embodiment herein, a requestor may send the request from the first entity 102 through the spatial map employment controller 106 to the second entity 112 to create the spatial map. The request includes a requestor identity, one or more security credential(s), three-dimensional area of interest, and information to be included in the spatial map. The information to be included in the spatial map includes information such as allowed entities list defining which entities are permitted to discover and access the spatial map. The request may include spatial map layering information parameters and may also include augmented layer information that can be requested with the spatial map. The allowed entities list contains a list of application or application server or entities which are allowed to access the spatial map.

In an embodiment herein, the second entity 112 may obtain augmented layer information and can provide the obtained augmented layer information to the requestor in a response message.

In an embodiment herein, the first entity 102 receives a response message through the spatial map employment controller 106 with an indication of success, in-progress, or failure. If the requested spatial map has been created successfully, the response message includes assigned spatial map identity and information which includes three-dimensional space defined by the spatial map. The response message may include a list of spatial map layers with their corresponding layer identity, objects belonging to the layer, etc. If the response indicates “in-progress”, an assigned spatial map identity is included in the message. Further, if the response indicates “in-progress” and the requestor has not provided a notification target address, then the requestor subscribes for the spatial map event to receive the notification when the spatial map is created. Otherwise, the response includes an indication of the failure and may include a reason for the failure.

In an embodiment herein, the response indicates “in-progress”, the second entity 112 detects when the second entity 112 does not have sufficient information to map all the objects related to area of interest and the spatial map is not yet ready to provide service (e.g. employed for localization). If the requestor from the first entity 102 may have provided the notification target address in the request through the spatial map employment controller 106 or has subscribed for spatial map events, the first entity 102, through the spatial map employment controller 106, may receive the notification. The notification includes the spatial map ready notification message.

In an embodiment herein, the first entity 102 may send a subscribe request through the spatial map employment controller 106 to subscribe for the spatial map employed event. The request includes the map identity, the requestor's identity and a security parameter. In an embodiment herein, the first entity 102 may receive an authorization of the requestor through the spatial map employment controller 106, and a validation of the subscribe request. Then, the second entity 112 may add the requestor (of the first entity 102) into the subscriber list of the event. The second entity 112 starts monitoring the events. The second entity 112 produces a requested spatial map using layering information and processed sensor data. The first entity 102 receives a success response, through the spatial map employment controller 106, including a subscription identity upon determining that the requestor is authorized by the second entity 112. The success response is received when the second entity 112 has sufficient information to map all the objects related to area of interest the spatial map and the spatial map is ready to provide service (e.g. employed for the localization service or the like).

In an example, the subscribe request includes the requestor identity, the security credentials, a notification endpoint, a spatial map identity, and an event to subscribe which triggers the notification. The subscribe request message may also include a list of spatial map layers with its corresponding layer identities to subscribe the spatial map layering information related events. The requestor (of the VAL server or SEAL SM client) may subscribe to one or more of the events including “changes of objects”, “layers modification”, and “spatial map ready”. The “spatial map ready” events indicate the second entity 112 to notify the requestor when the second entity 112 has sufficient information to map all the objects related to area of interest the spatial map and the spatial map is ready to provide service (e.g. employed for localization). The “spatial map ready” event is used when a result information element (IE) in the create spatial map response indicates “in-progress”.

In an embodiment herein, if the first entity 102 sends the subscribe request for the localization service for the map which is not employed yet, the second entity 112 may reject the subscribe request indicating that the spatial map creation is in-progress. The rejection response also includes the expected time when the spatial map will be produced and employed for the localization service.

In an embodiment herein, the first entity 102 may send the subscribe request for a spatial map created event, a spatial map produced event, a spatial map ready for employment event, or any other event name indicating spatial map is ready for the employment or generation.

In an embodiment herein, the first entity 102 sends the subscribe request message to the second entity 112 through the spatial map employment controller 106 to query the status of the spatial map. The subscribe request may include the map identity, requestor's identity and the security parameters. The first entity 102 may receive the authorization of the request from the second entity 112. If the requestor is authorized, the first entity 102 receives the success response through the spatial map employment controller 106 including the subscription identity upon determining that the requestor is authorized by the second entity 112. The success response includes the status of the spatial map whether the spatial map is already employed, or the spatial map is in-progress.

In an embodiment herein, the subscribe request may implicitly subscribe for the spatial map employed event when the first entity 102 receives the in-progress response. Once the second entity 112 has sufficient information to map all the stationary objects and the moving objects related to area of interest, the first entity 102 receives the final success response indicating that the spatial map is employed for localization service.

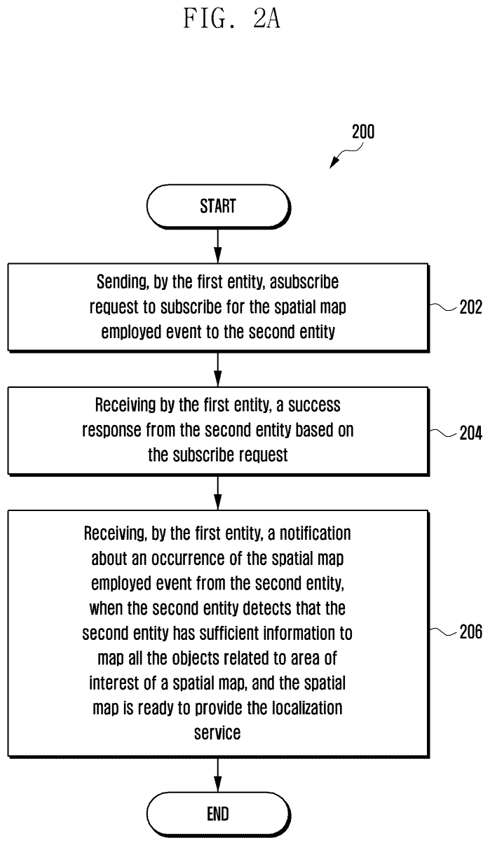

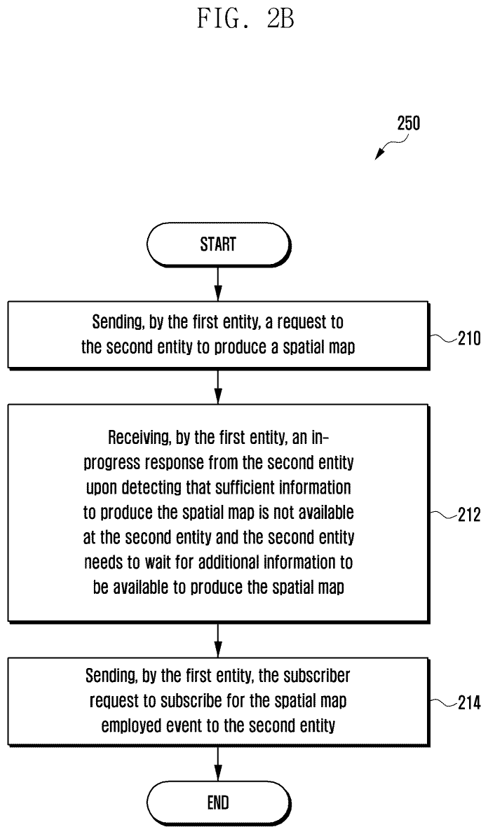

FIG. 2A depicts a flowchart of a method 200 to subscribe for the spatial map employed event from the first entity perspective, according to an embodiment of the disclosure.

At operation 202, the first entity 102 sends the subscribe request through the spatial map employment controller 106 to subscribe for the spatial map employed event to the second entity 112. The subscribe request comprises the map identity, the identity associated with the requestor, and the at least one security parameter. The second entity 112 produces the requested spatial map using layering information and processed sensor data. At operation 204, the first entity 102 receives the success response from the second entity 112 through the spatial map employment controller 106 based on the subscribe request. The first entity 102 receives the success response on the second entity 112 successfully authorizing the requestor. The success response includes the subscription identity.

At operation 206, the first entity 102 receives the notification about the occurrence of the spatial map employed event from the second entity 112. The first entity 102 receives the notification when the second entity 112 detects that the second entity 112 has sufficient information to map all the objects related to the area of interest of the spatial map, and the spatial map is ready to provide the localization service.

The various actions in method 200 may be performed in the order presented, in the different order or simultaneously. Further, in some embodiments, some actions listed in FIG. 2A may be omitted.

FIG. 2B depicts a flowchart of a method 250 to send the subscribe request to subscribe for the spatial map employed event to the second entity by the first entity 102 while subscribing for the spatial map employed event from a first entity perspective, according to an embodiment of the disclosure.

Before the first entity 102 sends the subscribe request to subscribe for the spatial map employed event to the second entity 112, the method includes the following steps, at operation 210, the first entity 102 sends the request to the second entity 112 to produce the spatial map. The request comprises an address for indicating where the final response is to be sent. At operation 212, the first entity 102 receives the in-progress response from the second entity 112 upon detecting that sufficient information to produce the spatial map is not available at the second entity 112 and the second entity 112 needs to wait for additional information to be available to produce the spatial map. At operation 214, the first entity 102 sends the subscriber request to subscribe for the spatial map employed event to the second entity 112 upon receiving the in-progress response from the second entity 112.

The various actions in method 250 may be performed in the order presented, in the different order or simultaneously. Further, in some embodiments, some actions listed in FIG. 2B may be omitted.

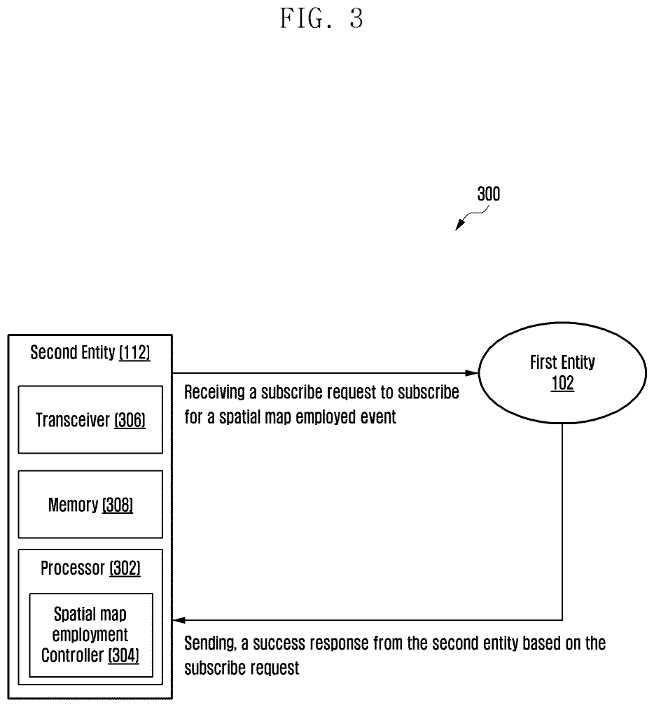

FIG. 3 shows a schematic overview of the system 300 to subscribe for the spatial map employed event from the second entity perspective, according to an embodiment of the disclosure.

In an embodiment herein, the second entity 112 comprises a processor 302, a spatial map employment controller 304, a transceiver 306, and memory 308. In an embodiment herein, the spatial map employment controller 304 is a part of the processor 302, where the spatial map employment controller 304 communicates with the entities (e.g., client and servers) through the transceiver 306. In another embodiment herein, the spatial map employment controller 304 is outside the processor 302 but the spatial map employment controller 304 is in communication with the processor 302, where the spatial map employment controller 304 communicates with the first entity 102 through the transceiver 306. In another embodiment herein, the spatial map employment controller 304 is outside the processor 302, and the spatial map employment controller 304 works separately from the processor 302, where the spatial map employment controller 304 communicates with the first entity 102 through the transceiver 306.

In an embodiment herein, the memory 308 is configured to store instructions to be executed by the processor 302. The memory 308 can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 108 may, in some examples, be considered a non-transitory storage medium. The term “non-transitory” may indicate that the storage medium is not embodied in a carrier wave or a propagated signal. However, the term “non-transitory” should not be interpreted that the memory is non-movable. In some examples, the memory 108 is configured to store larger amounts of information. In certain examples, a non-transitory storage medium may store data that can, over time, change (e.g., in Random Access Memory (RAM) or cache).

The processor 302 may include one or more processors. The one or more processors may be a general-purpose processor. The processor 302 may include multiple cores and is configured to execute the instructions stored in the memory 308.

In an embodiment, the transceiver 306 includes an electronic circuit specific to a standard that enables wired or wireless communication. The transceiver 306 is configured to communicate internally between internal hardware components of the second entity 112 and with external devices via one or more networks.

In an embodiment herein, the second entity 112 may receive the request from the first entity 102 through the spatial map employment controller 304 to produce the spatial map for the area of interest. The request also includes location (e.g. Uniform Resource Locator (URL)) from where the second entity 112 can access the sensor data. The second entity 112 may start producing the spatial map based on the processed sensor data available.

In an embodiment herein, there may not be sufficient sensor data available for producing the spatial map, the second entity 112 needs to wait for more processed sensor data to be available in order to complete producing the spatial map. The second entity 112 may send the response message to the first entity 102 through the spatial map employment controller 304 with the result parameter set to “in-progress” value indicating that the spatial map is being produced. The response message also includes the expected time, when the spatial map will be produced and employed for the localization service.

In an embodiment herein, the second entity 112 may receive, through the spatial map employment controller 304, the request from the requestor from the first entity 102 to create the spatial map. The request includes the requestor identity, the security credentials, the three-dimensional area of interest, and the information to be included in the spatial map. The information includes the allowed entities list defining which entities are permitted to discover and access the spatial map. The request may include spatial map layering information parameters and may also include augmented layer information that can be requested with the spatial map.

In an embodiment herein, the second entity 112 may obtain augmented layer information and can provide the obtained augmented layer information to the requestor in the response message.

In an embodiment herein, the second entity 112 may authorizes the requestor, and validates the request through the spatial map employment controller 304. The second entity 112 starts producing the requested spatial map using the layering information and processed sensor data. Then, the second entity 112 may add the requestor (of the first entity 102) into the subscriber list of the event. The second entity 112 starts monitoring the events. The second entity 112 produces the requested spatial map using the layering information and processed sensor data. The second entity 112 may send the success response to the first entity 102 through the spatial map employment controller 304. The success response may include the subscription identity upon determining that the requestor is authorized by the second entity 112. The second entity 112 may send the success response to the first entity 102 when the second entity 112 has sufficient information to map all the objects related to the area of interest associated with the spatial map, and the spatial map is ready to provide service (e.g. employed for localization).

In an embodiment herein, the second entity 112 may send the response message to the requestor, through the spatial map employment controller 304, with an indication of the success, the in-progress, or the failure. If the requested spatial map has been created successfully, the success response includes assigned spatial map identity and information. The information includes three-dimensional space defined by the spatial map (for example). The information may include the list of spatial map layers with their corresponding layer identity, objects belonging to the layer, etc. If the response indicates “in-progress”, the assigned spatial map identity is included in the message. Further, if the response indicates the “in-progress” and the requestor has not provided the notification target address, then the second entity 112 may receive the request from the requestor to send the notification when the spatial map is created. Otherwise, the response includes an indication of failure and may include the reason for the failure.

In an embodiment herein, the response indicates the “in-progress”, the second entity 112 detects when the second entity 112 does not have sufficient information to map all the objects related to area of interest and the spatial map is not ready to provide service (e.g. employed for localization). If the second entity 112 has received the notification target address in the request from the first entity 102 or the second entity 112 may have received the subscription for the spatial map events, the second entity 112 may send the notification with the spatial map ready notification message to the first entity 102.

In an embodiment herein, the second entity 112 may receive the subscribe request through, the spatial map employment controller 304, to subscribe for the spatial map employed event. The request includes the map identity, the requestor's identity and the security parameter. The second entity 112 may send the success response including the subscription identity upon authorizing the requestor.

In an embodiment herein, if the second entity 112 may receive the subscribe request, through the spatial map employment controller 304, for the localization service for the map which is not employed yet, the second entity 112 may reject the subscribe request indicating that the spatial map creation is in-progress. The rejection response also includes the expected time when the spatial map will be produced and employed for the localization service.

In an embodiment herein, the second entity 112 may receive the subscribe request for the spatial map created event, the spatial map produced event, the spatial map ready for employment event or any other event name indicating spatial map is ready for the employment.

In an embodiment herein, the second entity 112 may receive the subscribe request message from the first entity 102 to query the status of the spatial map. The subscribe request includes the map identity, requestor's identity and security parameters. The second entity 112 may send the authorization of the request to the first entity 102 through the spatial map employment controller 304. If the requestor is authorized, the second entity 112 may send the success response to the first entity 102. The success response includes the status of the spatial map whether the spatial map is already employed, or the spatial map is in-progress.

In an embodiment herein, the produced spatial map request can implicitly subscribe for the spatial map employed event when the second entity 112 sends the in-progress response. Once the second entity 112 has sufficient information to map all the stationary objects and moving objects related to area of interest, the second entity 112 sends the final success response indicating that the spatial map is employed for the localization service.

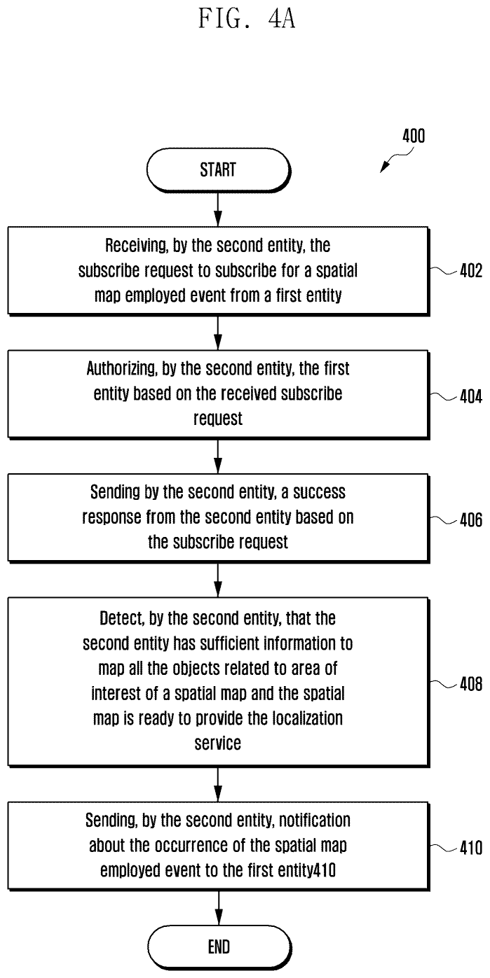

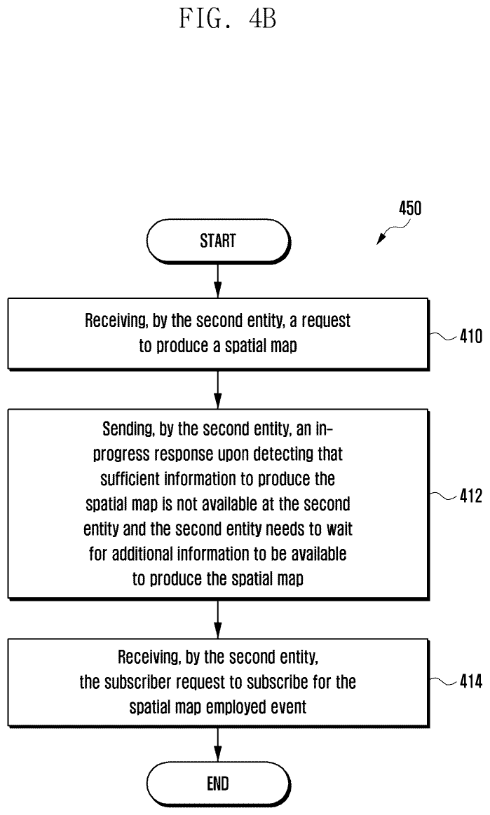

FIG. 4A depicts a flowchart of a method 400 to subscribe for the spatial map employed event from the second entity perspective, according to an embodiment of the disclosure.

At operation 402, the second entity 112 receives the subscribe request to subscribe for the spatial map employed event from the first entity 102. The request comprises the map identity, the identity associated with the requestor and at least one security parameter. At operation 404, the second entity 112 authorizes the first entity 102 based on the received subscribe request. At operation 406, the second entity 112 sends the success response comprising the subscription identity to the first entity 102, on successfully authorizing the first entity 102 based on the received subscribe request.

At operation 408, the second entity 112 may detect that the second entity 112 has sufficient information to map all the objects related to the area of interest of the spatial map and the spatial map is ready to provide the localization service. At operation 410, the second entity 112 may send the notification about the occurrence of the spatial map employed event to the first entity.

The various actions in method 400 may be performed in the order presented, in the different order or simultaneously. Further, in some embodiments, some actions listed in FIG. 4A may be omitted.

FIG. 4B depicts a flowchart of a method 450 to send the subscribe request to subscribe for the spatial map employed event to the second entity by the first entity while subscribing for the spatial map employed event from the second entity perspective, according to an embodiment of the disclosure.

Before the second entity 112 receives the subscribe request to subscribe for the spatial map employed event from the first entity 102, the method includes the following steps, at operation 410, the second entity 112 may receive the request from the first entity 102 to produce the spatial map. The request comprises the address for indicating where the final response is to be sent. At operation 412, the second entity 112 sends the in-progress response to the first entity upon detecting that sufficient information to produce the spatial map is not available at the second entity 112. The second entity 112 needs to wait for additional information to be available to produce the spatial map. At operation 414, the second entity 112 receives the subscribe request to subscribe for the spatial map employed event from the first entity.

The various actions in method 450 may be performed in the order presented, in the different order or simultaneously. Further, in some embodiments, some actions listed in FIG. 4B may be omitted.

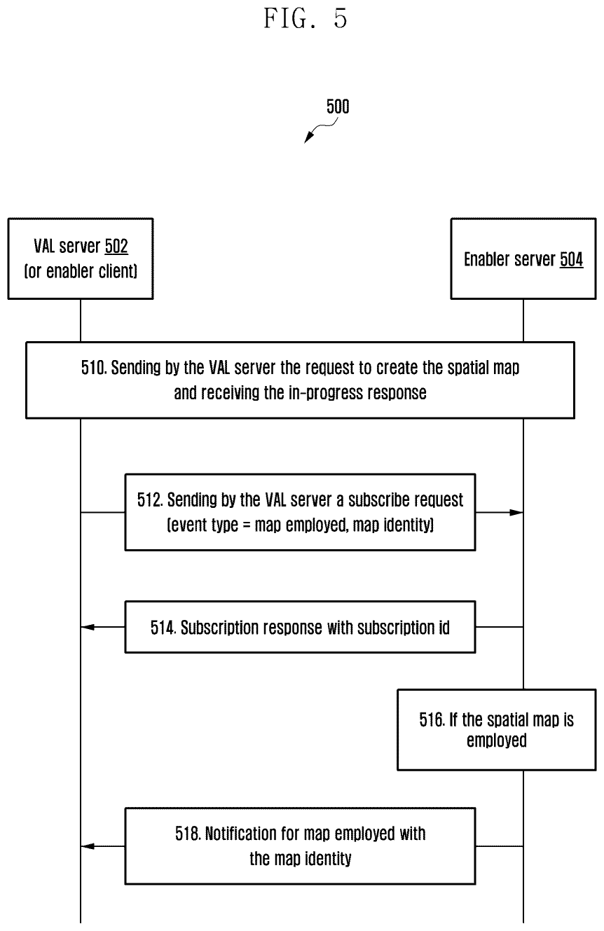

FIG. 5 depicts an example sequence diagram 500 of a procedure to subscribe for the spatial map employed event, according to an embodiment of the disclosure.

Here, the first entity 102 can be a VAL server 502 and the enabler client, and the second entity 112 can be an enabler server 504. At operation 510, the VAL server 502 (or enabler client) has requested to produce the spatial map for the area of interest. The request also includes the location (e.g. Uniform Resource Locator (URL)) from where the enabler server 504 can access the sensor data. The enabler server 504 may produce the spatial map based on the processed sensor data available with the VAL server 502. The sufficient sensor data may not be available for creating the spatial map, therefore, the enabler server 504 needs to wait for more processed sensor data to be available in order to complete producing the spatial map. The VAL server 502 (or enabler client) receives the response from the enabler server 504 with the result parameter set to “in-progress” value indicating that the spatial map is being produced. The response message also includes the expected time, when the spatial map will be produced and employed for the localization service.

At operation 512, the VAL server 502 (or the enabler client) sends the subscribe request to subscribe for the spatial map employed event. The subscribe request includes the map identity, the requestor's identity and the security parameters. At operation 514, the enabler server 504 authorizes the VAL server 502. If the VAL server 502 is authorized, the VAL server 502 receives the success response including the subscription identity. At operation 516, once the enabler server 504 has sufficient information to map all the stationary objects and moving objects related to area of interest, at operation 518, the VAL server 502 receives the notification from the enabler server 504 (or enabler client) indicating that the spatial map is employed for the localization service.

In an embodiment herein, if the enabler server 504 receives the request for the localization service for the spatial map which is not employed yet, the enabler server 504 may reject the subscribe request indicating that the spatial map creation is in-progress. The rejection response also includes the expected time when the spatial map will be produced and employed for the localization service.

In an embodiment herein, the VAL server 502 (or enabler client) may subscribe for the spatial map created event, the spatial map produced event, the spatial map ready for employment event, or any other event name indicating spatial map is ready for the employment.

In an embodiment herein, the VAL server 502 (or the enabler client) sends the subscribe request to the enabler server 504 to query the status of the spatial map. The subscribe request includes the map identity, the requestor's identity and the security parameters. The VAL server 502 receives authorization of the request from the enabler server 504. If the requestor is authorized, the VAL server 502 receives the success response from the enabler server 504. The response includes the status of the spatial map whether the spatial map is already employed, or the spatial map is in-progress.

In an embodiment herein, the produced spatial map request can implicitly subscribe for the spatial map employed event when the enabler server 504 sends the in-progress response. Once the enabler server 504 has sufficient information to map all the stationary objects and moving objects related to area of interest, the enabler server 504 sends the final successful response indicating that the spatial map is employed for the localization service.

The various actions in method 500 may be performed in the order presented, in the different order or simultaneously. Further, in some embodiments, some actions listed in FIG. 5 may be omitted.

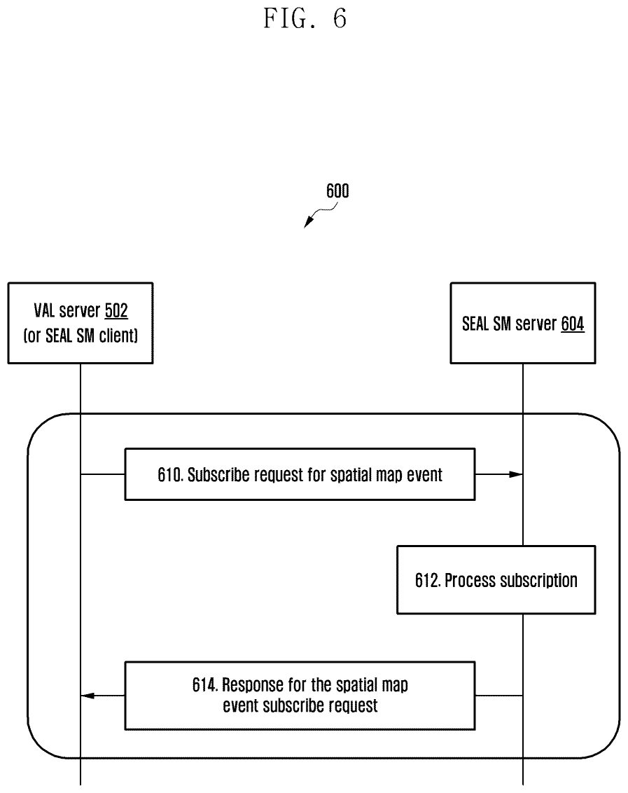

FIG. 6 depicts the example procedure for the authorized spatial map consumer (the first entity 102) to subscribe to the spatial map event, according to an embodiment of the disclosure.

The spatial map consumer can be the first entity 102. The spatial map consumer may be the VAL server 502 or the SM client. The service is provided by the SEAL SM server 604 (that is the second entity 112). The spatial map consumer can get notification information when the SEAL SM server 604 detects the subscribed event.

At operation 610, the VAL server 502 (or SEAL SM client) sends the subscribe request to the SEAL SM server 604 to subscribe to the spatial map event. The request includes the requestor identity, the security credentials, the notification endpoint, the spatial map identity, and the event to subscribe which triggers the notification. The subscribe request may also include a list of spatial map layers with its corresponding layer identities to subscribe spatial map layering information related events. The requestor (VAL server 502 or SEAL SM client) may subscribe to one or more of the following events:
“changes of objects” events to indicate the SM server 604 to notify the requestor when changes of the objects are detected.
“layers modification” events to indicate the SM server to notify the requestor when any layer in the spatial map is added or updated or removed; and
“spatial map ready” events to indicate the SM server 604 to notify the requestor when the SEAL SM server 504 has sufficient information to map all the objects related to area of interest the spatial map and the spatial map is ready to provide service (e.g. employed for localization). This event is used when the result IE in the Create spatial map response indicates “in-progress”.

Embodiments herein focus on the “spatial map ready” event. When the SM server 604 determines that the SM server 604 has sufficient information to map all the objects related to the area of interest related to the spatial map and the spatial map is ready to provide the service (e.g. employed for localization), the SM server may send the notification.

At operation 612, the VAL server 502 may be authorized by the SM server 604, and the SM server 604 validates the subscribe request. Then, the SM server 604 server may add the requestor (e.g., VAL server 502) into the subscriber list of the event. The SM server 604 starts monitoring the events.

At operation 614, the SM server 604 sends the success response message with the result. For the successful subscribe request, the subscription identity is included in the success response message. Otherwise, the response message includes an indication of failure and may include a reason for failure.

The various actions in method 600 may be performed in the order presented, in the different order or simultaneously. Further, in some embodiments, some actions listed in FIG. 6 may be omitted.

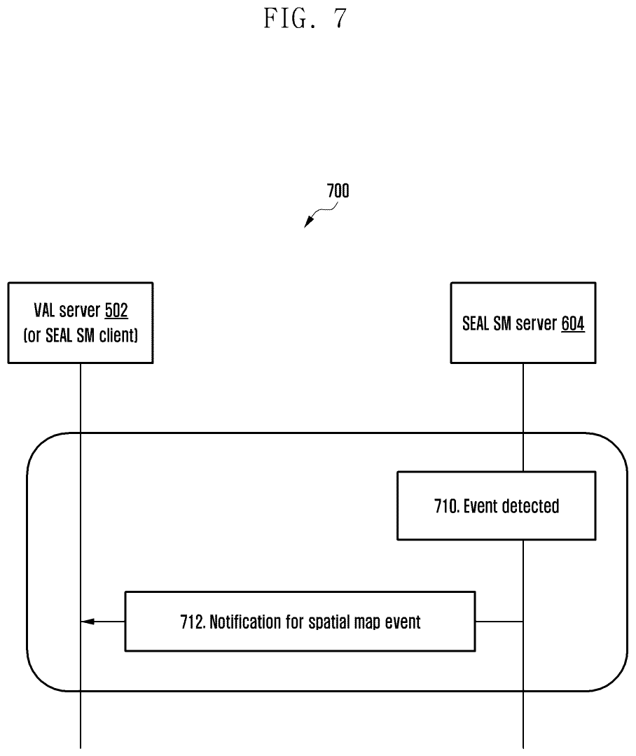

FIG. 7 depicts an example sequence diagram for the notify spatial map event operation between the authorized spatial map consumer (the first entity 102) and SEAL SM server 604 (second entity 112), according to an embodiment of the disclosure.

At operation 710, the SEAL SM server 604 detects the event that triggers the notification to the subscribers for the corresponding event. If the subscribed event is “spatial map ready”, the SM server 604 detects when the SEAL SM server 604 has sufficient information to map all the objects related to area of interest the spatial map and the spatial map is ready to provide service (e.g. employed for localization). The SM server 604 determines whether the detected event matches a triggering criterion and notifies subscribers accordingly. At operation 712, the SEAL SM server 604 notifies the VAL server 502 (or SEAL SM clients) that had subscribed to the corresponding event. The notification includes the subscription identity and event-specific information. For example, if the event is “changes of objects”, the notification includes the information on the detected triggering event, e.g. added or removed objects, position or direction changes of the objects in the spatial map etc.

The various actions in method 700 may be performed in the order presented, in the different order or simultaneously. Further, in some embodiments, some actions listed in FIG. 7 may be omitted.

The embodiments disclosed herein can be implemented through at least one software program running on at least one hardware device and performing network management functions to control the network elements. The elements include blocks which can be at least one of the hardware devices, or a combination of hardware device and software module.

The embodiments disclosed herein describe systems and methods for indicating spatial map employment for localization services Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high-speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an application specific integrated circuit (ASIC), or a combination of hardware and software means, e.g., an ASIC and a field programmable gate array (FPGA), or at least one microprocessor and at least one memory with software modules located therein. The method embodiments described herein could be implemented partly in hardware and partly in software. Alternatively, the invention may be implemented on different hardware devices, e.g., using a plurality of CPUS.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first entity in a communication system, the method comprising:
transmitting, to a second entity, a first request message to create a spatial map associated with an area of interest; and
in case that the spatial map produced based on a processed sensor data is not ready to provide service, receiving, from the second entity, a first response message including information indicating in-progress.

2. The method of claim 1, further comprising:
in case that the second entity has sufficient information to map all objects related to the area of interest and the spatial map is ready to provide service, receiving, from the second entity, a first notification message for indicating that the spatial map is ready to provide service.

3. The method of claim 1, further comprising:
transmitting, to the second entity, a second request message to subscribe spatial map event;
in case that the first entity is authorized, receiving, from the second entity, a second response message including an identity of a subscribe request; and
in case that the second entity has sufficient information to map all objects related to the area of interest and the spatial map is ready to provide service, receiving, from the second entity, a second notification message for indicating that the spatial map is ready to provide service.

4. The method of claim 3, wherein the second request message includes at least one of an identifier of the first entity, security information, or an identifier of the spatial map.

5. The method of claim 1,
wherein the spatial map is ready to provide service corresponds to being employed for a localization service,
wherein the first entity comprises at least one of an enabler client, a vertical application layer (VAL) server, a service enabler architecture layer (SEAL) client, a SEAL spatial map (SM) client, and
wherein the second entity comprises at least one of an enabler server, a SEAL server, or a SEAL SM server.

6. A method performed by a second entity in a communication system, the method comprising:
receiving, from a first entity, a first request message to create a spatial map associated with an area of interest;
producing the spatial map based on a processed sensor data; and
in case that the spatial map is not ready to provide service, transmitting, to the first entity, a first response message including information indicating in-progress.

7. The method of claim 6, further comprising:
determining that the second entity has sufficient information to map all objects related to the area of interest and the spatial map is ready to provide service; and
transmitting, to the first entity, a first notification message for indicating that the spatial map is ready to provide service.

8. The method of claim 6, further comprising:
receiving, from the first entity, a second request message to subscribe spatial map event;
performing an authorization of the first entity;
in case that the first entity is authorized, transmitting, to the first entity, a second response message including an identity of a subscribe request;
determining that the second entity has sufficient information to map all objects related to the area of interest and the spatial map is ready to provide service; and
transmitting, to the first entity, a second notification message for indicating that the spatial map is ready to provide service.

9. The method of claim 8, wherein the second request message includes at least one of an identifier of the first entity, security information, or an identifier of the spatial map.

10. The method of claim 6,
wherein the spatial map is ready to provide service corresponds to being employed for a localization service,
wherein the first entity comprises at least one of an enabler client, a vertical application layer (VAL) server, a service enabler architecture layer (SEAL) client, a SEAL spatial map (SM) client, and
wherein the second entity comprises at least one of an enabler server, a SEAL server, or a SEAL SM server.

11. A first entity in a communication system, the first entity comprising:
a transceiver; and
a controller configured to:
transmit, to a second entity via the transceiver, a first request message to create a spatial map associated with an area of interest, and
in case that the spatial map produced based on a processed sensor data is not ready to provide service, receive, from the second entity via the transceiver, a first response message including information indicating in-progress.

12. The first entity of claim 11, wherein the controller is further configured to:
in case that the second entity has sufficient information to map all objects related to the area of interest and the spatial map is ready to provide service, receive, from the second entity via the transceiver, a first notification message for indicating that the spatial map is ready to provide service.

13. The first entity of claim 11, wherein the controller is further configured to:
transmit, to the second entity via the transceiver, a second request message to subscribe spatial map event,
in case that the first entity is authorized, receive, from the second entity via the transceiver, a second response message including an identity of a subscribe request, and
in case that the second entity has sufficient information to map all objects related to the area of interest and the spatial map is ready to provide service, receive, from the second entity via the transceiver, a second notification message for indicating that the spatial map is ready to provide service.

14. The first entity of claim 13, wherein the second request message includes at least one of an identifier of the first entity, security information, or an identifier of the spatial map.

15. The first entity of claim 11,
wherein the spatial map is ready to provide service corresponds to being employed for a localization service,
wherein the first entity comprises at least one of an enabler client, a vertical application layer (VAL) server, a service enabler architecture layer (SEAL) client, a SEAL spatial map (SM) client, and
wherein the second entity comprises at least one of an enabler server, a SEAL server, or a SEAL SM server.

16. A second entity in a communication system, the second entity comprising:
a transceiver; and
a controller configured to:
receive, from a first entity via the transceiver, a first request message to create a spatial map associated with an area of interest,
produce the spatial map based on a processed sensor data, and
in case that the spatial map is not ready to provide service, transmit, to the first entity via the transceiver, a first response message including information indicating in-progress.

17. The second entity of claim 16, wherein the controller is further configured to:
determine that the second entity has sufficient information to map all objects related to the area of interest and the spatial map is ready to provide service, and
transmit, to the first entity via the transceiver, a first notification message for indicating that the spatial map is ready to provide service.

18. The second entity of claim 16, wherein the controller is further configured to:
receive, from the first entity via the transceiver, a second request message to subscribe spatial map event,
perform an authorization of the first entity,
in case that the first entity is authorized, transmit, to the first entity via the transceiver, a second response message including an identity of a subscribe request,
determine that the second entity has sufficient information to map all objects related to the area of interest and the spatial map is ready to provide service, and
transmit, to the first entity via the transceiver, a second notification message for indicating that the spatial map is ready to provide service.

19. The second entity of claim 18, wherein the second request message includes at least one of an identifier of the first entity, security information, or an identifier of the spatial map.

20. The second entity of claim 16,
wherein the spatial map is ready to provide service corresponds to being employed for a localization service,
wherein the first entity comprises at least one of an enabler client, a vertical application layer (VAL) server, a service enabler architecture layer (SEAL) client, a SEAL spatial map (SM) client, and
wherein the second entity comprises at least one of an enabler server, a SEAL server, or a SEAL SM server.
